(19) United States
(12) Patent Application Publication
(10) Pub. No.: US 2002/0170667 A1
(43) Pub. Date: Nov. 21, 2002

(54) Electrostatographic seamed belt

(75) Inventors: Edward L. Schlueter JR., Rochester, NY (US); Theodore Lovallo, Williamson, NY (US); Laurence J. Lynd, Macedon, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/147,608

(22) Filed: May 15, 2002

Related U.S. Application Data
(62) Division of application No. 09/619,619, filed on Jul. 19, 2000.

(51) Int. Cl. B31F 5/00

(52) U.S. Cl. 156/304.5; 156/157; 156/308.4

(57) ABSTRACT

A process for fabricating an endless flexible seamed belt, substantially equivalent in performance to a seamless belt, includes forming the belt by joining two ends of a substrate material. Each end of the substrate has mutually mating elements in interlocking relationship. The surfaces of the mutually mating elements have a gap therebetween into which bonding material is applied such that there is no substantial thickness differential between the seam and the portions of the belt adjacent the seam. The bonding material is then cured by any known means and post-cured to improve the stability of the bonding material and to achieve an effectively electrically invisible seam for an electrostatographic imaging system operating at high temperatures.

### CROSS REFERENCE TO RELATED APPLICATIONS

This is a divisional of application Ser. No. 09/619,619 filed Jul. 19, 2000. Attention is directed to U.S. patent application Ser. No. 09/470,931 (D/99689), filed Dec. 22, 1999, entitled, “Continuous Process for Manufacturing Imagable Seamed Belts for Printers”. The disclosure of this reference is hereby incorporated by reference in its entirety.

### BACKGROUND OF THE INVENTION

This invention relates generally to an endless seamed belt, and more particularly concerns the production of a more mechanically and electrically seamless belt that performs more reliably under elevated temperature conditions for electrostatographic systems.

By way of background, belts were fabricated by taking two ends of a web material and fastening them together by a variety of techniques such as sewing, wiring, stapling, providing adhesive joints, etc. While such joined or seamed belts are suitable for many applications, such as the delivery of rotary motion from a source such as a motor to a device such as a saw blade, they are not as satisfactory in many of today's more sophisticated applications of belt technology. In the technology of the current day, many belt applications require much more sophisticated qualities and utilities. Specialized applications such as electrostatographic imaging apparatus and processes utilize belts as photoreceptors, intermediate sheet and/or image transport devices, fusing members and/or transfix devices. In these cases, it is ideal to provide a belt having no seam that would mechanically interfere with any operation that the belt performs or any operation that may be performed on the belt. While this is ideal, the manufacture of seamless belts requires rather sophisticated manufacturing processes, which are expensive and are particularly more sophisticated, difficult and much more expensive for the larger belts. As a result, various attempts have been made to provide seamed belts for use in these processes. Previous attempts to manufacture seamed belts have largely relied on belts in which the two ends of the belt material have been lapped or overlapped to form the seam or have butted against one another. The ends have then been fastened mechanically by heat or other means of adhesion, such as by the use of an adhesive or ultrasonic welding.

The belts formed according to the typical butting technique while satisfactory for many purposes are limited in bonding, strength and flexibility because of the limited contact area formed by merely butting the two ends of the belt material. Furthermore, belts formed according to the butting or overlapping technique provide a bump or other discontinuity in the belt surface leading to a height differential between adjacent portions of the belt, of 0.010 inches or more depending on the belt thickness, which leads to performance failure in many applications. For example, one of the most severe problems involves cleaning the imaging belt of residual toner after transfer of the toner image. Intimate contact between the belt and cleaning blade is required. With a bump, crack or other discontinuity in the belt, the tuck of the blade is disturbed, which allows toner to pass under the blade and not be cleaned. Furthermore, seams having differential heights may when subjected to repeated striking by cleaning blades cause the untransferred, residual toner to be trapped in the irregular surface of the seam. Additionally, photoreceptors, which are repeatedly subjected to this striking action, tend to delaminate at the seam when the seam is subjected to constant battering by the cleaning blade. As a result, both the cleaning life of the blade and the overall life of the photoreceptor can be greatly diminished as well as degrading the copy quality. Such irregularities in seam height also result in vibrational noise in xerographic development, which disturbs the toner image on the belt and degrades resolution and transfer of the toner image to the final copy sheet. This is particularly prevalent in those applications requiring the application of multiple color layers of liquid or dry developer on a photoreceptor belt, which are subsequently transferred to a final copy sheet. In addition, the presence of the discontinuity in belt thickness reduces the flex life and belt strength continuity, which, for prolonged use, is desirably 80-90% that of the parent material unseamed. In addition, the discontinuity or bump in such a belt may result in inaccurate image registration during development, inaccurate belt tracking and overall deterioration of motion quality, as a result of the translating vibrations.

A “puzzle cut” approach to seamed belts, such as taught in the below-cited and other prior art references, significantly reduces mechanical problems by producing an improved mechanical seam. Typically the seam of the flexible belt formed by mutually mating elements in interlocking relationship has a kerf or voids between the mating elements which are at least partially filled with a seam strength enhancing material which is chemically and physically compatible with the material from which the belt is fabricated and which is bonded to the belt material. The chemical and/or physical bond between the seam strength enhancing material and the belt material may be formed by the application of heat and/or pressure to the seam. In a particular application impulse welding may be applied wherein heat and pressure are simultaneously applied to soften the belt material and melt the strength enhancing material so that it fills the kerf and forms an adhesive bond with the belt material. In this regard, it is important that the heat applied does not exceed that which would both form the seam and break it by melting or decomposing it. Other heat sources include conventional heated rolls, a simple heated iron, ultrasonic welding or a two roll heated nip providing a combination of heat and pressure.

While the seamed belts formed by these processes can perform well in applications in which the operating temperatures do not exceed more than about 30° C., more recent applications require performance over more demanding temperature ranges. Electrostatographic machines employing transfuse belts, fusing belts, and other high temperature belts require belt operation at temperatures approaching 120° C. At these temperatures seams bonded by adhesives have been observed to fail within minutes of heat application within the machine, due to adhesive flow at the elevated temperatures. To increase the functional life of belts that are subjected to elevated temperatures and hydrocarbon fluids, a process is needed to improve adhesive stability.

The following disclosures are cited with regard to certain aspects of the present invention:

U.S. Pat. No. 5,286,586 to Foley et al. discloses fabrication of thin flexible endless belts used in electrophotographic printing systems. The patent teaches overlapping the ends of the belt and welding the ends together to form an endless belt.

U.S. Pat. No. 5,487,707 to Sharf et al. teaches an endless flexible seamed belt formed by joining two ends of material in a puzzle cut seam, in which the opposite surfaces are in an interlocking relationship. The voids between the surfaces of the mutually mating elements are filled by an adhesive which has been cured by exposure to ultraviolet radiation and joined together to enable the seamed flexible belt to function as an endless belt.

U.S. Pat. No. 5,514,436 to Schlueter, Jr. et al. discloses an endless flexible seamed belt with a mechanically invisible seam and performance substantially equivalent to a seamless belt. The belt ends are fabricated such that each end has a plurality of mutually mating elements in a puzzle cut pattern, which is in interlocking relationship in at least one plane with its mating end. The ends, when mechanically joined, enable the flexible to function as an endless belt having a uniform thickness.

U.S. Pat. No. 5,721,032 to Parker et al. teaches an endless flexible seamed belt having a puzzle cut seam with voids between the mutually mating elements. The voids are filled with a seam strength enhancing material, which is chemically and physically compatible with the belt material. The seam strength enhancing material is applied as a strip or on a strip over the seam and is bonded to the belt material through the application of heat and/or pressure. The strip may include a substrate with a coating of the compatible material, which is removed after the bond is formed.

U.S. Pat. No.5,942,301 to Schlueter, Jr. et al. discloses a seamed belt composed of a polyimide belt material and having its ends joined in a puzzle cut seam. An adhesive present in the space between the interlocked mating elements of the seam is selected from the group consisting of a polyvinyl butyral composition, a polyurethane composition, and a blended composition including an acrylonitrile and butadiene copolymer and a phenol formaldehyde polymer.

### BRIEF SUMMARY OF THE INVENTION

One feature of the disclosed embodiment is drawn to a process for fabricating an endless flexible seamed belt for an electrostatographic imaging system formed by joining two ends of a flexible substrate. Each end of the substrate has a plurality of mutually mating elements, which are in interlocking relationship. The surfaces of the mutually mating elements have a gap therebetween into which bonding material is applied such that there is absent any substantial thickness differential between the seam and the portions of the belt adjacent the seam. The bonding material in the seam is then cured by any known means and post-cured to achieve and effectively electrically invisible seam for an electrostatographic imaging system operating at high temperatures.

An alternative feature of the disclosed embodiment is drawn to an endless flexible seamed belt formed by joining two ends of a flexible substrate, each end of which has mutually mating elements, the opposite surfaces of which are in interlocking relationship. The surfaces of the mutually mating elements define a gap therebetween into which bonding material is applied to form a bonded seam. The bonding material in the seam is then cured by any known means and post-cured to achieve an effectively electrically invisible seam for an electrostatographic imaging system operating at high temperatures.

### BRIEF DESCRIPTION OF THE SEVERAL VIEWS OF THE DRAWINGS

The foregoing and other features of the instant invention will be apparent and easily understood by those skilled in the art from a further reading of the specification and claims, and from the accompanying drawings, in which:

FIG. 1 is an isometric representation of the flexible puzzle cut seamed belt providing a mechanically invisible and substantially equivalent seam in performance to that of a seamless belt.

FIG. 2 is an enlarged view of a puzzle cut pattern used on both joining ends of the belt material to provide interlocking elements.

FIG. 3 is illustrative of an alternative configuration wherein male and female interlocking portions having curved mating elements are used in the two ends of the belt material which are joined.

FIG. 4 is a further alternative embodiment wherein the interlocking elements form a dovetail pattern having curved mating elements.

FIG. 5 is an additional alternative embodiment wherein the interlocking relationship between the puzzle cut pattern on both ends is formed from a plurality of finger joints.

FIG. 6 is a belt seam with the kerf filled with belt compatible material represented by cross-hatching.

FIG. 7 is an exploded isometric view of a fixture for holding and applying pressure to the belt seam of the instant invention.

FIG. 8 is an isometric view of an arrangement, typically a manual arrangement, wherein the seam and the puzzle cut pattern of the belt are bound or joined together by an adhesive applied to the seam, and pressure is applied to both sides of the seam belt with the adhesive therein.

All references cited in this specification, and their references, are incorporated by reference herein where appropriate for teaching additional or alternative details, features, and/or technical background.

While the present invention will hereinafter be described in connection with a preferred embodiment, it will be understood that this description is not intended to limit the invention to that embodiment or method of use. On the contrary, the following description is intended to cover all alternatives, modifications, and equivalents, as may be included within the spirit and scope of the invention as defined by the appended claims.

### DETAILED DESCRIPTION OF THE INVENTION

With continued reference to the Figures and additional reference to the following description, the exemplary embodiments will be described in greater detail. The seam formed according to the present invention is one of enhanced strength, flexibility and mechanical life. The seam is held together by the geometric relationship between the ends of the belt material, which are fastened together by a puzzle cut, in which the two ends interlock with one another in the manner of an ordinary puzzle. The seam has a kerf or voids between the surfaces of mutually mating elements, the opposite surfaces of the puzzle cut pattern being bound or joined together to enable the seamed flexible belt to essentially function as an endless belt. The joining of the opposite surfaces of the mutually mating elements forming the seam may be either a physical joining, chemical joining or some combination of physical and chemical joining. Typically, this joining provides a bonding between the opposite surfaces of the mutual mating elements, which provides an improved seam quality and smoothness with substantially no thickness differential between the seam and the adjacent portions of the belt, thereby providing enhanced imaging, registration and control as discussed above. In this regard, it should be noted that the lower the differential and height, the faster the belt may travel.

The opposite surfaces of the puzzle cut pattern in the belt seam may be joined with an adhesive, which is physically and chemically compatible with the belt material. In any case, the opposite surfaces of the puzzle cut pattern being joined together are bound with sufficient physical integrity to enable the seamed flexible belt to essentially function as an endless belt. The adhesive may be applied to the kerf or voids between the mutually mating elements, and in particular, to the opposite surfaces of the puzzle cut pattern. In this regard, the viscosity of the adhesive is important since its performance depends on its ability to wick into the voids or the kerf between adjacent cut pieces of the pattern. In addition, the surface energy of the adhesive must be compatible with the material from which the belt is fabricated so that it adequately wets and spreads in the belt seam. As previously described good adhesion is required to achieve performance equivalent to the performance of a seamless belt. The kerf, the distance between adjacent surfaces of the mutually mating elements of the belt ends, can be cut into the belt ends by a mechanical die or by cutting with a laser beam. Following fabrication, the belt may be finished by buffing or sanding and may have an overcoating applied. The overcoating typically has a thickness of 0.001 to 0.003 inch, which can be initially applied to the unseamed belt. The belt is then seamed and the seamed area is filled from the back of the belt to maintain the uniformity of the functional surface. Preferably, and by far the most economical approach, is to form the belt seam prior to applying the desired overcoating. In some cases the heat resistant polished seam can provide imageability in the seam area.

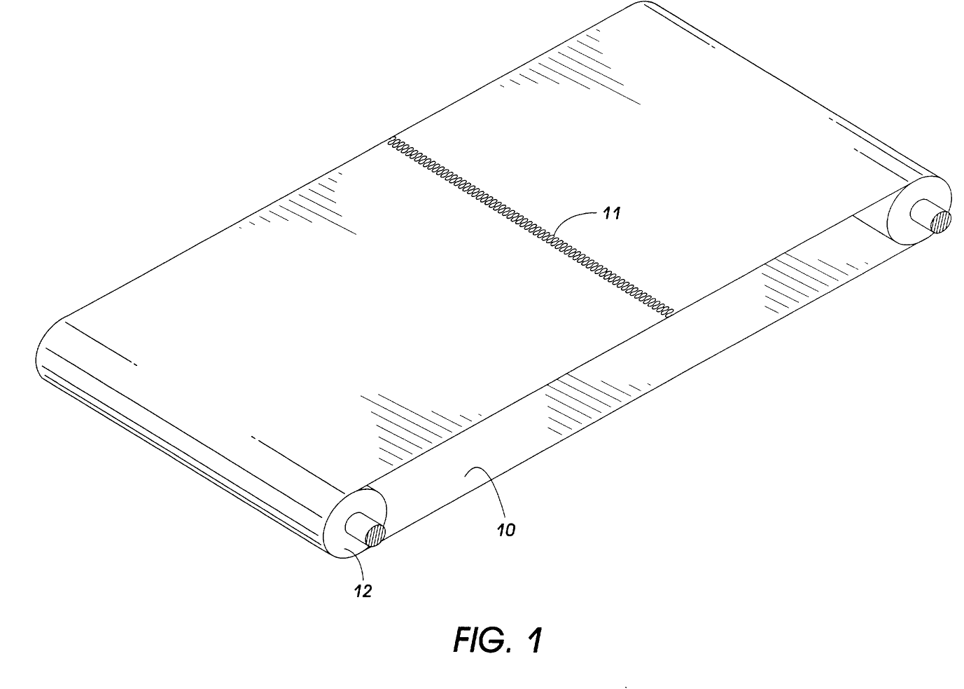

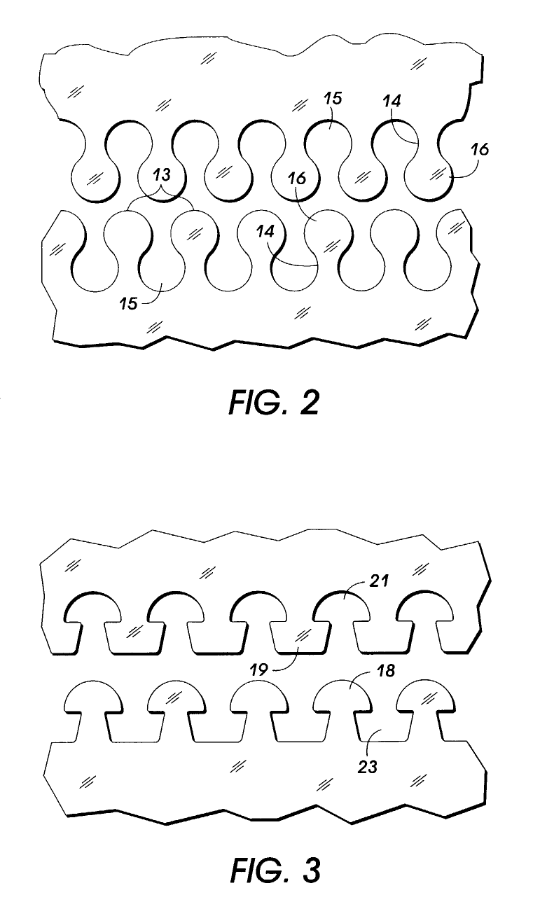

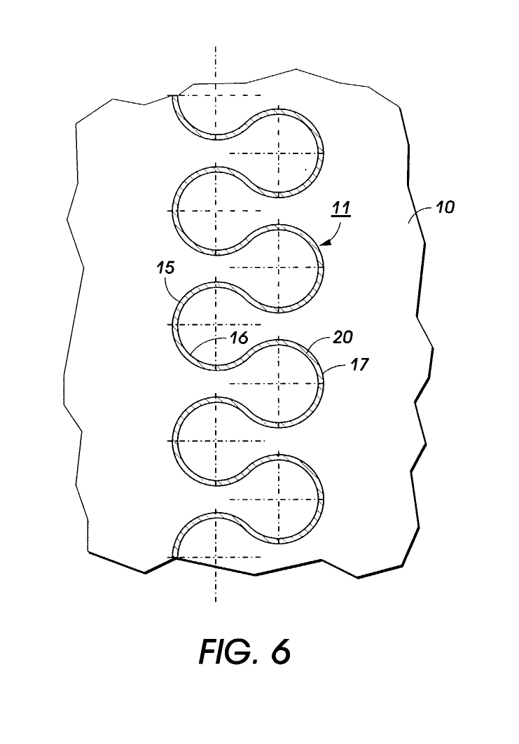

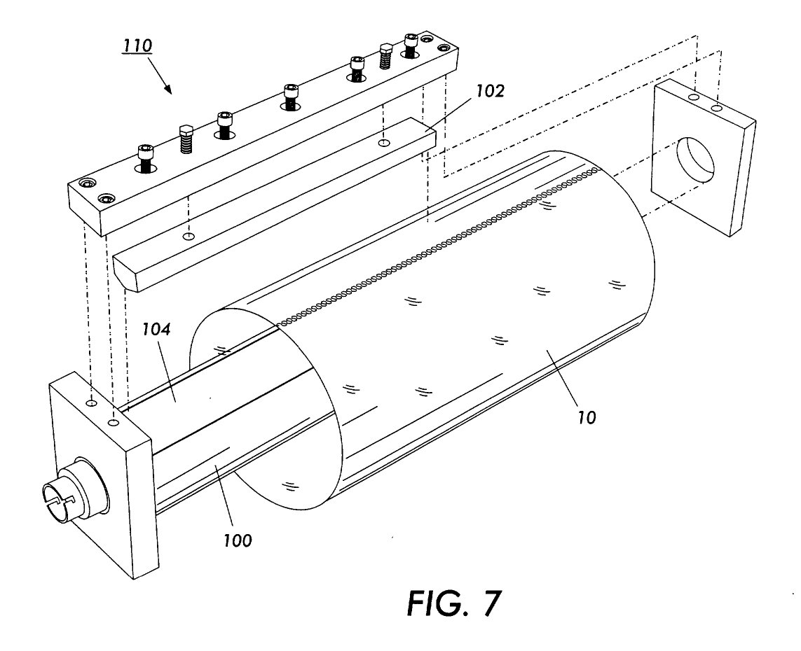

FIG. 1 depicts one embodiment of a belt 10 having a seam 11. As seen in FIG. 2, the seam is formed by joining together mating elements (13, 15) in an interlocking relationship. As used herein, the phrase “mating elements” also refers to nodes. FIGS. 2-5 depict different embodiments of the mating elements. As best seen in FIG. 6, there is a space 20 between the interlocked mating elements, which is at least partially filled or totally filled by an adhesive 17.

The mating elements of the belt ends preferably have a shape that interlocks in the manner of a puzzle cut, meaning that the two ends interlock with one another in the manner of an ordinary puzzle. A chemically and physically compatible adhesive at least partially fills the space (also referred to herein as kerf) between the mutually mating elements in the seam. The puzzle cut mating elements provide an improved seam quality and smoothness with substantially no thickness differential between the seam and the rest of the belt. Further, it should be noted that the lower the differential in height the faster that the belt may travel. The mating elements preferably are joined to result in a butt joint rather than for example an overlap joint to minimize the seam height. While the seam is illustrated in FIG. 1 as being perpendicular to the two parallel sides of the belt, it will be understood that the seam may extend across the entire width of the belt and may be angled or slanted with respect to the parallel sides. This construction permits any noise generated in the system to be distributed more uniformly and the forces placed on each mating element or node to be reduced. It is desired that the seam height differential between the seam and the unseamed portion of the belt adjacent the seam is no more than about 25 micrometers. Additionally, it is desired that the seam possess a continuity of strength ranging from about 80% to about 90% of the parent belt material and a flex life of at least about 1 million cycles, preferably at least about 2 million cycles, without seam failure. Preferably, the mating elements have a node radius (i.e., individual mating element radius) of about 0.5 mm and spacing between the interlocked mating elements of about 25 micrometers.

The belt material is selected to have the appropriate physical characteristics such as tensile strength, Young's modulus of elasticity, electroconductivity, thermal conductivity, mechanical, chemical, and electrical stability under both static and dynamic conditions, flex strength, and in certain applications, such as transfix (where the intermediate toner image transfer member is also used to fuse the toner image), stability when subjected to high temperatures. Other important characteristics of the belt material, depending on its use, include low surface energy for good toner release, gloss, dielectric constant, and strength.

The endless flexible seamed belt may be made of any suitable material. Typical materials include photoreceptor materials, which may be multi-layered, such as those described in U.S. Pat. No. 4,265,990, as well as a variety of thermoplastic and thermosetting belt materials. Any suitable belt material may be employed. Typical materials include polyesters, polyurethanes, polyimides, polyvinyl chloride, polyolefins such as polyethylene and polypropylene and polyamides such as nylon, polycarbonates, acrylics, polyphenylsulfide, all of which may be unfilled or filled with fillers such as metal oxides, or carbon to obtain desired properties. In addition, elastomeric materials such as silicones, fluorocarbons such as E.I. DuPont's Vitons™, EPDM and nitiriles etc., may be used. These materials may be filled with conductive filler and polymers to achieve the desired resistivity for transfer of the electrostatic image. Conductive polymers such as polyanaline and polythiophene may be used singly or in combination with the above particulate fillers to achieve the desired image transfer state.

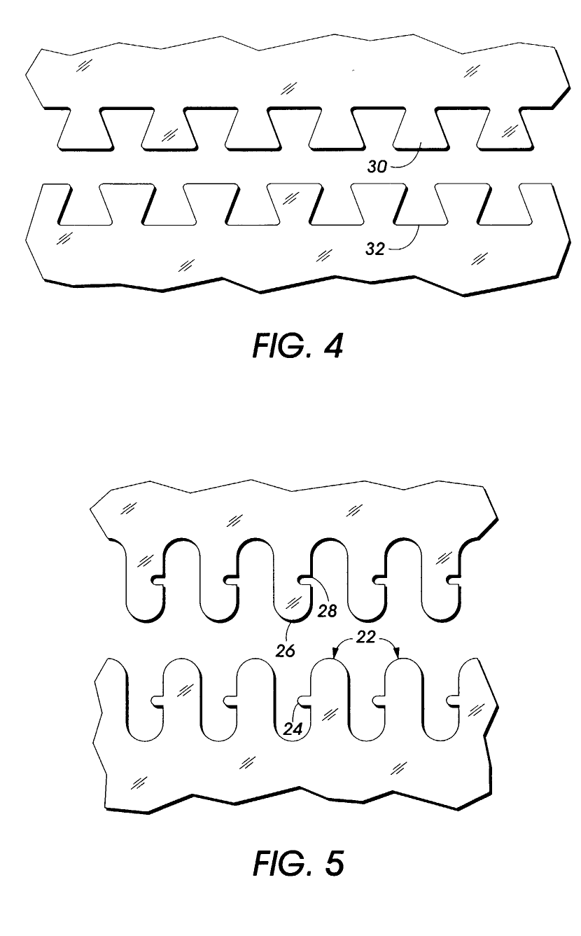

As may be observed from the drawings, the puzzle cut pattern may take virtually any form, including that of teeth or nodes such as identical post or neck 14 and head 16 patterns of male 13 and female 15 interlocking portions as illustrated in FIG. 2. They may also assume a more mushroom-like shaped pattern having male portions 18 and 19 and female portions 21 and 23 as illustrated in FIG. 3, as well as a dovetail pattern as illustrated in FIG. 4. The puzzle cut pattern illustrated in FIG. 5 has a plurality of male fingers 22 with interlocking teeth 24 and plurality of female fingers 26 which have recesses 28 to interlock with the teeth 24 when assembled. It is important that the interlocking elements all have curved mating elements to reduce the stress concentration between the interlocking elements and permit them to separate when traveling around curved members such as the rolls 12 of FIG. 1. It has been found that with curved mating elements that the stress concentration is lower than with square corners where rather than the stress being uniformly distributed it is concentrated leading to possible failure.

To minimize any time out or nonfunctional area of the belt it is desirable to have the seam width be as narrow as possible. Further, this enables the seam to be indexed so that it does not participate in belt functionality such as the formation and transfer of a toner or developer image. Typically, the seam is from about 1 mm to about 3 mm wide.

With reference to the embodiment illustrated in FIG. 2, the seam may be typically of the order of one inch wide on a belt which is 16 to 18 inches long depending on roll diameter, material modulus or other parameters. The post and head pattern may be formed from a male/female punch cut with each end being cut separately. These ends are subsequently joined to form the seam with a roller similar to that used as a wallpaper seamer rolled over the seam by hand, to complete the interlocking nature of the puzzle cut pattern.

The two ends of the belt material are joined by physically placing them together in interlocking relationship. This may require the application of pressure to properly seat or mate the interlocking elements.

As previously discussed, the endless flexible seamed belt is joined by a plurality of mutually mating elements in a puzzle cut pattern in interlocking relationship to form a seam, which has a kerf or voids between the mutually mating elements. The mating elements are bonded together or adhesively bonded with material, which is chemically and physically compatible with the material from which the belt is fabricated and which is bonded to the belt material. This bond is formed by the application of an adhesive material. One preferred adhesive for joining the ends of the belt is polyvinyl butyral, or any adhesive that is heat activated and that could be flowed into the belt seam. The seam is then initially cured and tacked in place.

It is very important that the seam is effectively mechanically and electrically invisible for purposes of an electrostatographic imaging member. One method includes tailoring the viscosity of the adhesive, matching the surface energies of the materials and cure times to enable flattening in a controlled period of time. Another technique that can be used is the application of the adhesive with a mechanical following device. The adhesive is applied as a bead and then a mechanical blade, brush or air stream follows the applicator to level the bead. Yet another way to level the seam is by a fixturing device that applies a load forcing the adhesive into the seam and leveling the adhesive bead.

This prior art belt seaming process generally yields long life belt components for belts functioning in thermal environments below 80° C. However, new electrostatographic architectures require belts to function at increased temperatures. Functional tests performed on belts seamed by the prior art process revealed that as temperatures approached 120° C., the seam pulled apart within minutes, which rendered the belt inadequate for high-temperature applications. Upon further testing, it was observed that the seam adhesive flowed at higher temperatures, permitting the belt seam to separate, possibly due to insufficient cross-linking of the polymer chains of the adhesive. To more completely cross link the adhesive and enable high temperature performance, applicants developed the post-cure process of the present invention.

The post-cure process of the present invention is effective for various adhesives designed to perform over varying temperature ranges. Examples of several such adhesives include the following:

| Adhesive | Performance Range |
|---|---|
| Urethanes, acrylics | 150° F.-250° F. |
| EPDM, nitrile, phenolics | 250° F.-350° F. |
| PV butyral, polyimid | 350° F.-450° F. |

After a belt is seamed by the prior art seaming process, the belt is placed in fixture 110, as illustrated in FIG. 7. The fixture includes supporting cylinder 100 and pressure plate 102. TEFLON® tape 104 separates the belt 10 from the supporting plate 100 when the belt is placed in the fixture.

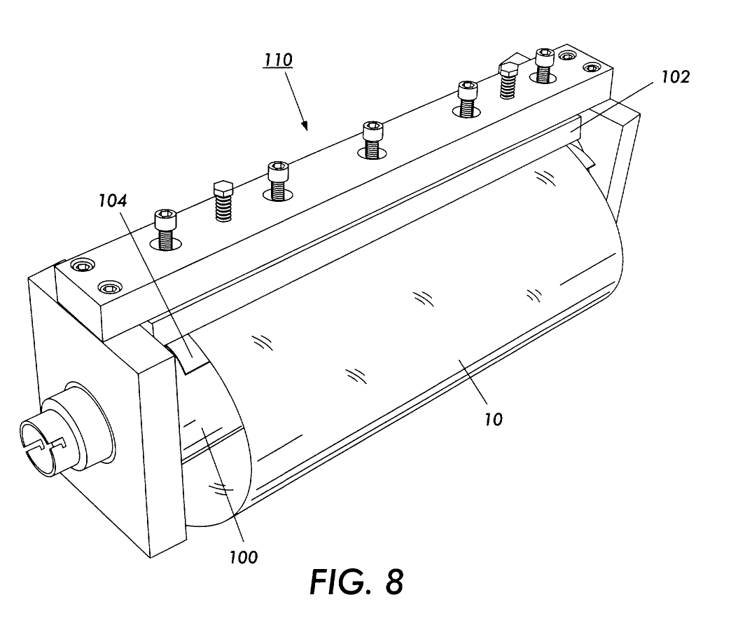

Referring now to FIG. 8, in operation pressure plate 102 applies gentle pressure to the seam, just sufficient to hold the seam nodes in place. TEFLON® tape 104 positioned between the belt 10 and supporting plate 100 provides for release of the belt after post curing. Fixture 110 with the belt seam secures as shown in FIG. 8, is placed within an oven for post curing, as described below. In the preferred mode of the invention, the belt seam is cured in the oven at 450° F. for forty-five (45) minutes. The belt seam is then cooled to room temperature. Tests performed on belt seams post cured according to the process of the instant invention revealed no failures up to 2700 cycles while non-post cured belts failed within less than 1000 cycles in a high temperature environment (approximately 250° F.).

Various dwell patterns for post curing may achieve the desired level of adhesive cross-linking. For example, a staged dwell may be performed in which the belt seam is post cured at 100° F. for fifteen (15) minutes, 200° F. for an additional fifteen (15) minutes, 300° F. for an additional fifteen (15) minutes, and 400° F. for another fifteen (15) minutes. The seam temperature is ramped up and then down at various dwell temperatures, with the specific dwell temperatures and dwell times dependent on the cross-linking characteristics of the belt seam adhesive.

Thus, according to the present invention an endless flexible seamed belt, which is mechanically invisible and substantially equivalent in performance to a seamless belt, is formed for operation at elevated temperatures. Furthermore, a seamed belt is provided by joining two ends of a belt, with each end fabricated to have a plurality of mutually mating elements in a puzzle cut pattern, such that the pattern is in interlocking relationship. The assembly process enables accurate placement of the mating elements thereby permitting ease of assembly merely by mating the two pieces together, placing an adhesive in the seam to fill the kerf and bond the mating elements together, and post-curing the adhesive to enhance its performance at elevated temperatures.

It is therefore apparent that there has been provided in accordance with the present invention, a belt seaming adhesive post curing process that produces a seamed belt capable of reliable performance at elevated temperatures. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

1. An improved process for fabricating an endless flexible seamed belt for an electrostatographic imaging system formed by joining two ends of a flexible substrate, each end of which has mutually mating elements, comprising:
interlocking the two ends of the flexible substrate, the surfaces of the mutually mating element defining a gap therebetween;
applying bonding material to the gap between the surfaces of the two ends such that there is absent any substantial thickness differential between the seam and the portions of the belt adjacent the seam;
curing said bonding material applied to said gap between the surfaces of said two ends; and then additionally
post-curing said bonding material applied to said gap between the surfaces of said two ends to improve the stability of said bonding material to achieve an effectively electrically invisible seam for an electrostatographic imaging system operating at high temperatures.

2. The process according to claim 1, wherein said post-curing of said bonding material includes heating said bonding material over a time period.

3. The process according to claim 2, wherein said bonding material is heated between 30 minutes and 60 minutes at a temperature of approximately 400 degrees Fahrenheit to approximately 500 degrees Fahrenheit during said post-curing time period.

4. The process according to claim 3, wherein said bonding material is heated between 30 minutes and 60 minutes at a temperature of approximately 450 degrees Fahrenheit during said post-curing time period.

5. The process according to claim 4, wherein said bonding material is heated 45 minutes at a temperature of approximately 450 degrees Fahrenheit.

6. The process according to claim 3, wherein said bonding material is heated in accordance with a staged dwell heating pattern.

7. The process according to claim 6, wherein said staged dwell heating pattern comprises at least two heating stages within the temperature range of approximately 400 degrees Fahrenheit to approximately 500 degrees Fahrenheit.

8. The process according to claim 2, wherein said belt with said bonding material is heated in an oven.

9. The process according to claim 1, further comprising coating the flexible substrate and bonded seam with an undercoating layer such that the belt surface including the seam is substantially smooth.

10. An endless flexible seamed electrostatographic belt formed by joining two ends of a flexible substrate, each end of which has mutually mating elements, the opposite surfaces of which are in interlocking relationship, the surfaces of the mutually mating elements defining a gap therebetween to permit the presence of a bonding material in the gap between the surfaces of the mutually mating elements which forms a bonded seam, wherein the bonding material is both cured and post-cured to improve the stability of said bonding material.

11. The belt according to claim 10, wherein said bonding material is post-cured by heating the bonding material over a time period.

12. The belt according to claim 11, wherein said bonding material is post cured by being heated between 30 minutes and 60 minutes at a temperature of approximately 400 degrees Fahrenheit to approximately 500 degrees Fahrenheit.

13. The belt according to claim 12, wherein said bonding material is heated between 30 minutes and 60 minutes at a temperature of approximately 450 degrees Fahrenheit.

14. The belt according to claim 13, wherein said bonding material is heated 45 minutes at a temperature of approximately 450 degrees Fahrenheit.

15. The belt according to claim 12, wherein said bonding material is heated in accordance with a staged dwell heating pattern.

16. The belt according to claim 15, wherein said staged dwell heating pattern comprises at least two heating stages within the temperature range of approximately 400 degrees Fahrenheit to approximately 500 degrees Fahrenheit.

17. The belt according to claim 11, wherein said bonding material is heated in an oven.

18. The belt according to claim 10, further comprising an undercoating layer covering the substrate and the bonded seam such that the belt surface including the bonded seam is substantially smooth.

19. The belt according to claim 10, wherein the mutually mating elements have curved mating surfaces.

20. The belt according to claim 10, wherein the mutually mating elements have overlapping interlocking surfaces.
